(19) United States
(12) Patent Application Publication
(10) Pub. No.: US 2014/0354481 A1
(43) Pub. Date: Dec. 4, 2014

(54) 406 MHZ RECEIVER MEASURING TOA AND FOA FOR USE IN DETERMINING THE POSITION OF AN EMERGENCY BEACON

(71) Applicant: WS TECHNOLOGIES INC., Kelowna (CA)

(72) Inventors: Kevin Conrad Holmes, Kelowna (CA); William Austin Street, Kelowna (CA)

(73) Assignee: WS TECHNOLOGIES INC., Kelowna (CA)

(21) Appl. No.: 14/292,187

(22) Filed: May 30, 2014

Related U.S. Application Data
(60) Provisional application No. 61/829,425, filed on May 31, 2013.

(51) Int. Cl. G01S 5/02

(52) U.S. Cl. CPC G01S 5/02
USPC 342/465

(57) ABSTRACT

A method for locating a Cospas-Sarsat emergency beacon comprises transmitting a Cospas-Sarsat compliant transmission from an emergency beacon and receiving the transmission at a plurality of receivers wherein the plurality of receivers comprises at least one terrestrial receiver operable to receive the transmission directly from the emergency beacon. The method further comprises measuring, utilizing a processing circuit, at the at least one terrestrial receiver a frequency of arrival and time of arrival of the transmission and transmitting the frequency of arrival and the time of arrival of the transmission to a central processing terminal operable to determine the location of the emergency beacon.

### CROSS REFERENCE TO RELATED APPLICATION

This application claims priority to U.S. Provisional Patent Application No. 61/829,425, filed May 31, 2013 entitled 406 MHZ RECEIVER MEASURING TOA AND FOA FOR USE IN DETERMINING THE POSITION OF AN EMERGENCY BEACON.

### BACKGROUND OF THE INVENTION

1. Field of Invention

The present invention relates generally to the field of search and rescue beacon location and in particular to a method and system for locating Cospas-Sarsat emergency beacons.

2. Description of Related Art

Emergency locator beacons are transmitters for use in the detection and location of vehicles or persons in distress. In such systems portable emergency satellite radio beacons may be carried and activated in a life-threatening emergency. The emergency beacons transmit radio signals to indicate distress in an emergency situation.

One of the most common of such search and rescue systems is the Cospas-Sarsat system which is an international satellite-based distress alert detection and information distribution system. Part of the Cospas-Sarsat system includes portable emergency satellite radio beacons to be activated in a life-threatening emergency. The emergency beacons transmit radio signals to indicate distress in an emergency situation. In the Cospas-Sarsat system, these transmitted signals are intended to be received and processed by satellites or relayed by the satellites back to terrestrial signal processing stations called LUTs (local user terminals). The signals that are transmitted by a beacon are regulated by Cospas-Sarsat design specification and follow strict power, frequency and modulation requirements. The up-link band of the Cospas-Sarsat system occupies the radio frequency spectrum from 406 to 406.1 MHz.

The signal transmitted by a Cospas-Sarsat beacon was designed for use with satellites. The first group of satellites to use the signal was a group of low earth orbiting satellites (LEOs) that used onboard receivers to detect and measure the frequency of arrival (FOA) of the transmitted signal. Because the LEO satellites are low earth orbit, the relative velocity between the satellites and emergency beacon cause the FOA to be Doppler shifted by a substantial amount. Conventional understanding was that the relatively high speeds of such satellites was necessary for accurate measurements of the position of the beacon. These FOA measurements from the different LEO satellites are accumulated and processed to form a geographical position of the emergency beacon. A certain amount of time is required to collect enough signals from the beacon to determine a positional solution of that beacon. In particular, it has been found that the LEO system can take many hours to determine a suitable location of an emergency beacon. The accuracy of conventional Cospas-Sarsat systems utilizing such LEO satellites has also been found to be limited.

A new system is being developed using medium earth orbiting satellites (MEOs) to better enhance the ability to locate an emergency beacon known as the MEOSAR system. The MEOSAR system is a series of radio repeaters aboard GNSS navigational satellites. The signal from an emergency beacon is relayed via these satellites back to ground based LUTs for processing and location determination. The MEOLUT's processing uses both the time of arrival (TOA) and frequency of arrival (FOA) of the emergency beacon's signal to determine the geographical position of the beacon. Because multiple satellites are simultaneously in view of an emergency beacon at any given time, the TOA and FOA measurements from each satellite can be combined and used to solve a beacon's position more rapidly than previous LEO systems. Integration of the processed signals can be combined over time to form a better geographical location of the transmitting beacon.

However due to the extreme distances involved between the satellite and the emergency beacon and the relative orientation of antennas between the two, the MEOSAR system has also suffered difficulties with location accuracy.

Terrestrial based receivers have been developed that allow for the detection and direction determination of the emergency beacon signals. Commonly referred to as direction finding receivers (DFs), the receiver utilizes different types of antenna designs to determine the direction to the emergency beacon's signal. By combining the direction information from two or more suitably spaced receivers (or a single mobile receiver), the source of a beacon's transmission may be located in space via triangulation. Disadvantageously, conventional direction finding systems can include complex antenna designs and may have limited directional accuracy. The complexity of the antenna design can lead to excessive system costs and portability issues. The directional accuracy of DF systems can also be affected by the antenna design, accuracy of determining the antenna orientation, multipath effects, and any error that is in the direction determination at the receiver. Additionally, such inaccuracies are increased proportionality as the distance between the receiver and emergency beacon increases. Current terrestrial based receivers do not measure TOA and FOA with the accuracies required to be used in a position determining system to calculate the geographical position of an emergency beacon.

### SUMMARY OF THE INVENTION

The present invention provides a 406 MHz receiver that incorporates circuitry and software to process TOA and FOA data from a signal received. The signal received is directly from a Cospas-Sarsat emergency beacon. The TOA and FOA data is accurate enough to be used in a position determining system to calculate the geographical position of an emergency beacon.

According to a first embodiment of the present invention there is disclosed a method for locating a Cospas-Sarsat emergency beacon comprising transmitting a Cospas-Sarsat compliant transmission from an emergency beacon and receiving the transmission at a plurality of receivers wherein the plurality of receivers comprises at least one terrestrial receiver operable to receive the transmission directly from the emergency beacon. The method further includes measuring, utilizing a processing circuit, at the at least one terrestrial receiver a frequency of arrival and time of arrival of the transmission and calculating the location of the emergency beacon from the frequency of arrivals and the time of arrivals as measured by the plurality of receivers.

The at least one terrestrial receiver may comprise a plurality of terrestrial receivers. All of the plurality of receivers may comprise terrestrial receivers. At least one of the terrestrial receivers may be affixed to land. At least one of the terrestrial receivers may be supported on an aircraft. Calculating may further include receiving information relating to the location of the beacon from external sources. A processing circuit associated with one of the receivers may be operable to determine the location of the emergency beacon. The method may further comprise transmitting the frequency of arrival and the time of arrival of the transmission to a central processing terminal operable to determine the location of the emergency beacon.

According to a further embodiment of the present invention there is disclosed a method for locating a Cospas-Sarsat emergency beacon comprising transmitting a plurality of Cospas-Sarsat compliant transmissions from an emergency beacon and receiving the plurality of transmissions at a terrestrial receiver operable to receive the transmission directly from the emergency beacon wherein each of the plurality of transmissions is received at unique locations of the terrestrial receiver. The method further comprises measuring, utilizing a processing circuit, at the terrestrial receiver a frequency of arrival and time of arrival of each of the plurality of transmissions and calculating from the frequency of arrival and time of arrival for the plurality of transmissions the location of the emergency beacon.

The method may further comprise storing the frequency of arrival and time of arrival of each of the plurality of transmissions and transmitting the frequency of arrival and the time of arrival for each of the plurality of transmissions to a central processing terminal operable to calculate the location of the emergency beacon. Calculating may further include receiving information relating to the location of the beacon from external sources.

According to a further embodiment of the present invention there is disclosed a system for locating a Cospas-Sarsat emergency beacon comprising a plurality of receivers wherein the plurality of receivers comprises at least one terrestrial receiver operable to receive the transmission directly from the emergency beacon wherein each of the terrestrial receivers having a processing circuit adapted to determine a frequency of arrival and the time of arrival of a transmission from the emergency beacon.

The at least one terrestrial receiver may comprise a plurality of terrestrial receivers. All of the plurality of receivers may comprise terrestrial receivers. At least one of the terrestrial receivers may be affixed to land. At least one of the terrestrial receivers may be supported on an aircraft. A processing circuit associated with one of the receivers may be operable to determine the location of the emergency beacon. The processing circuit may be adapted to receive information relating to the location of the beacon from external sources. The system may further comprise a central processing terminal in communication with the plurality of receivers operable to determine the location of the emergency beacon from the plurality of frequency of arrival and time of arrival measurements provided by the plurality of receivers. The central processing terminal may be adapted to receive information relating to the location of the beacon from external sources.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a system for locating an emergency beacon according to a first embodiment of the present invention.

FIG. 2 is a schematic of a receiver for use in the system of FIG. 1.

FIG. 3 is a system for locating an emergency beacon according to a further embodiment of the present invention.

FIG. 4 is a system for locating an emergency beacon according to a further embodiment of the present invention.

FIG. 5 is a system for locating an emergency beacon according to a further embodiment of the present invention.

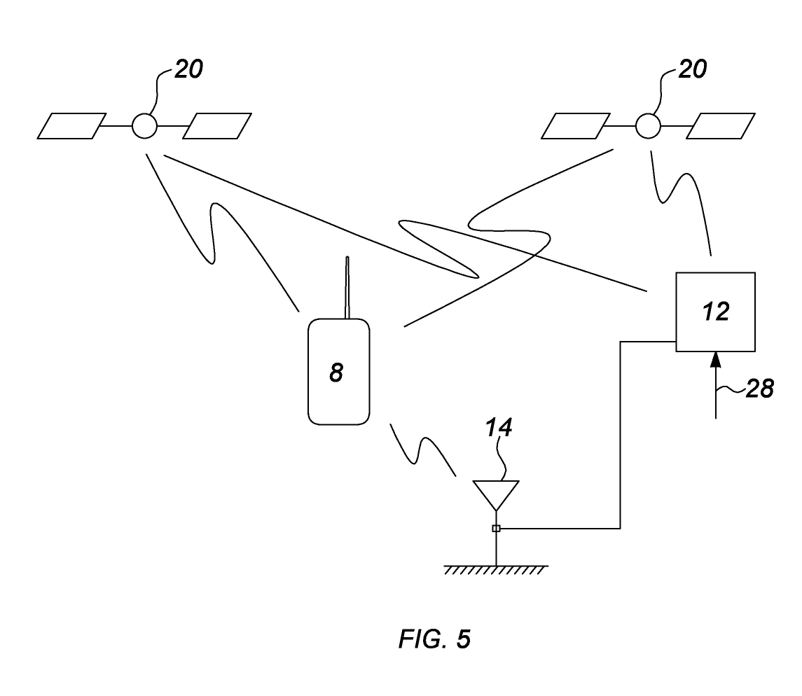

### DETAILED DESCRIPTION

As used in this specification, including the claims, the term “terrestrial receiver” is intended to broadly encompass any receiver which is located within, upon or around the earth excluding those receiver locations which are in gravitational orbit around the earth but including, but not limited to located on the ground, tower or building, located upon an aircraft or other vehicle upon or above the surface of the earth.

As used in this specification, including the claims, the term “aircraft” is intended to broadly encompass any manned or unmanned vehicle adapted to fly or hover above the earth's surface including but not limited to airplanes, helicopters balloons and rockets.

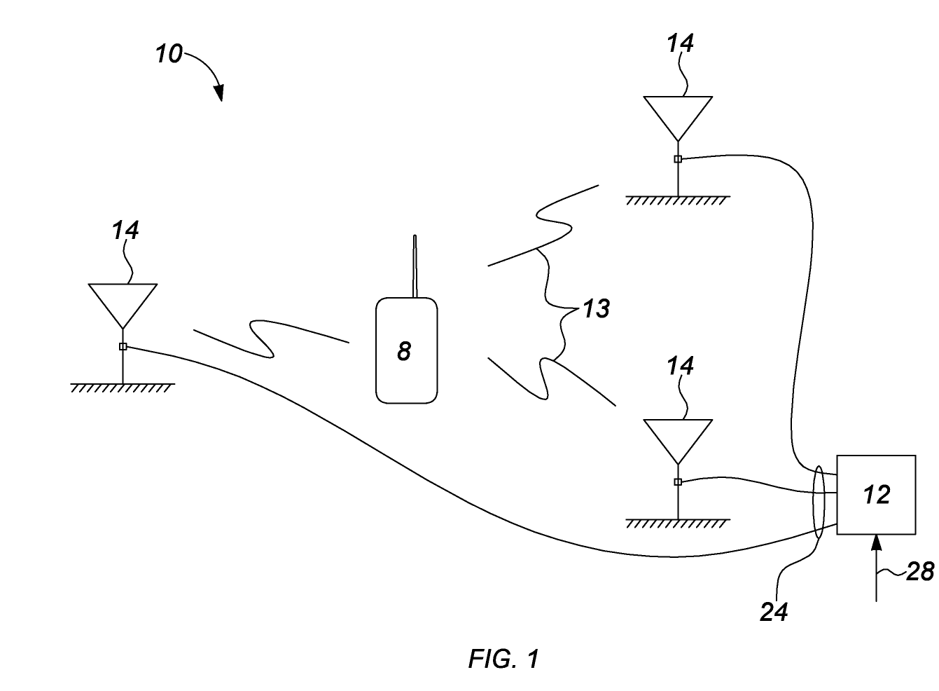

Referring to FIG. 1, a system for locating a Cospas-Sarsat emergency beacon 8 according to a first embodiment of the invention is shown generally at 10. The system 10 comprises a processing terminal 12 and a plurality of terrestrial receivers 14. As illustrated in FIG. 1, the terrestrial receivers 14 are ground based although the system may also include aircraft or satellite located receivers as well which will be more fully described below. Each of the receivers is adapted to measure the frequency of arrival (FOA) and the time of arrival (TOA) of a Cospas-Sarsat transmission outputted by the Cospas-Sarsat emergency beacon 8.

Each of the receivers 14 may be located at strategically selected locations around an area which is desired to be monitored, such as, by way of non-limiting example, marine harbours, parks or airfields and the like. The signals that are transmitted by a beacon are regulated by Cospas-Sarsat design specification and follow strict power, frequency and modulation requirements. The up-link band of the Cospas-Sarsat system occupies the radio frequency spectrum from 406 to 406.1 MHz.

Modern electronics and processing techniques have allowed the present invention to take advantage of certain signal characteristics of the emergency signal 13 transmitted from a Cospas-Sarsat beacon. In particular, since the signal from a beacon was originally designed for the use with satellites, it required tight tolerances of the signal structure. Specifically, the emergency beacon signal has tight tolerances on frequency stability and the timing of the digitally encoded data. The present invention uses these tight tolerances to determine TOA and FOA measurements that can later be used to calculate the geographical position of an emergency beacon.

As illustrated in FIG. 1, each of the receivers is in communication with the processing terminal 12 over a data link 24 which may comprise any wired or wireless communication link as are commonly known. The processing terminal 12 receives the FOA and TOA measurements from each receiver 14 and determines and outputs the location of the emergency beacon according to know methods as generally indicated at 26. Optionally, the processing terminal may also receive additional external information relating to the location of the emergency beacon, such as by way of non-limiting example, satellite, aircraft or ground determined location, frequency of arrival information, time of arrival information, manually inputted user information as generally indicated at 28. The processing terminal 12 may also be configured to receive data from each of the receivers 14 relating to the speed of the emergency beacon 8 and thereby determine the speed and heading of the emergency beacon according to known methods.

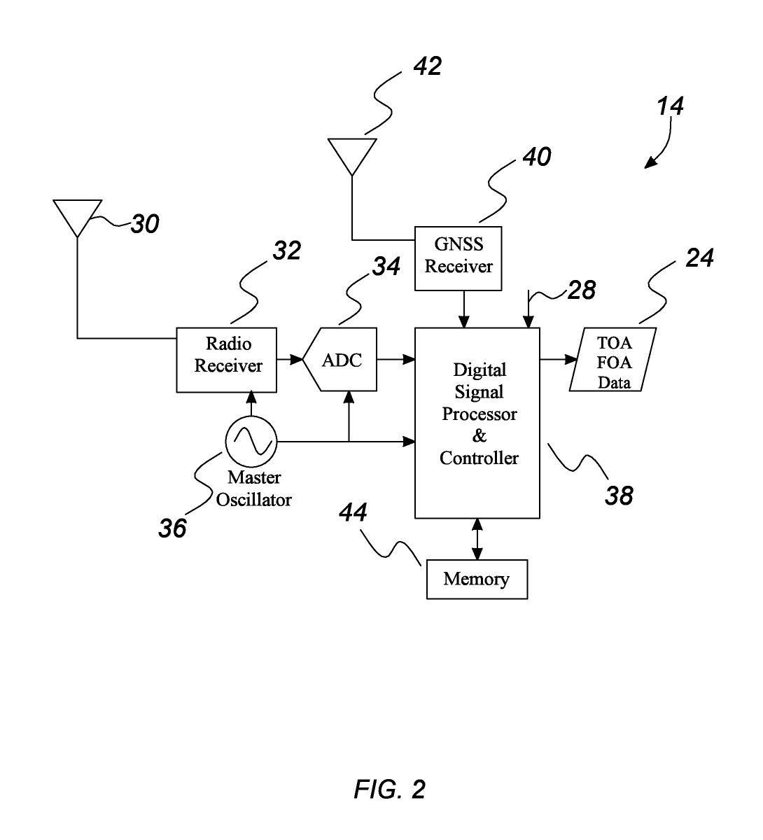

Turning now to in FIG. 2 an exemplary receiver 14 for use in the present system is illustrated. The receiver 14 includes an antennae 30 and a radio receiver 32, such as a superhetrodyne type receiver that down converts the received signal to an intermediate frequency (IF) as are commonly known. This IF signal is sampled by the analog to digital converter 16 and converted into digital information which in turn is then provided to a processor circuit 38. A master oscillator 36 operable to provide a stable reference and synchronization to the radio receiver 32, analog to digital converter (ADC) 34 and processor circuit 38. The processor circuit 38 processes the sampled digital information and very accurately determines the TOA and FOA of the received emergency beacons signal according to known methods. The receiver 14 also includes a global navigation satellite system (GNSS) receiver 40 with an associated antenna 42 operable to provide information to the processor circuit 38 position, velocity and time (PVT) information and the pulse per second (PPS) timing signal to the processor circuit 22. The receiver may also be adapted to optionally receive TOA and FOA measurements from other receivers as well as additional external information relating to the location of the emergency beacon, such as by way of non-limiting example, satellite, aircraft or ground determined location, frequency of arrival information, time of arrival information, manually inputted user information as generally indicated at 28 and to calculate the location of the emergency beacon. This information is used to determine absolute TOA and FOA measure according to known methods. Additionally memory device 44 may optionally be provided operable to store any historical data. After the TOA and FOA data is calculated, the information along with any GNSS positioning information or signal identification information is transmitted via the data link 24 to the processing terminal 12 as set out above.

In the present embodiment, the processor circuit includes a microprocessor or other suitable processor circuit as are generally known in the art. More generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processor circuits will be apparent to those ordinarily skilled in the art upon review of this specification, and substitution of any such other types of processor circuits is considered not to depart from the scope of the present invention as defined by the claims appended hereto.

It will be appreciated that many types of memory devices 44 may be utilized to perform the functions associated with the various routines described herein. Alternatively, such routines may be provided as software stored on a different medium such random access memories (RAMs), programmable read-only memories such as EPROMs, EEPROMs or FLASH memories, for example, or any other type of memory device, either at the location of the processor circuit or located remotely therefrom, may be substituted if desired. It will also be appreciated that the functions of the processing circuit 38 and memory 44 may be provided by an application specific logic array designed to provide the functions as set out below, such as by way of non-limiting example an application specific integrated circuit.

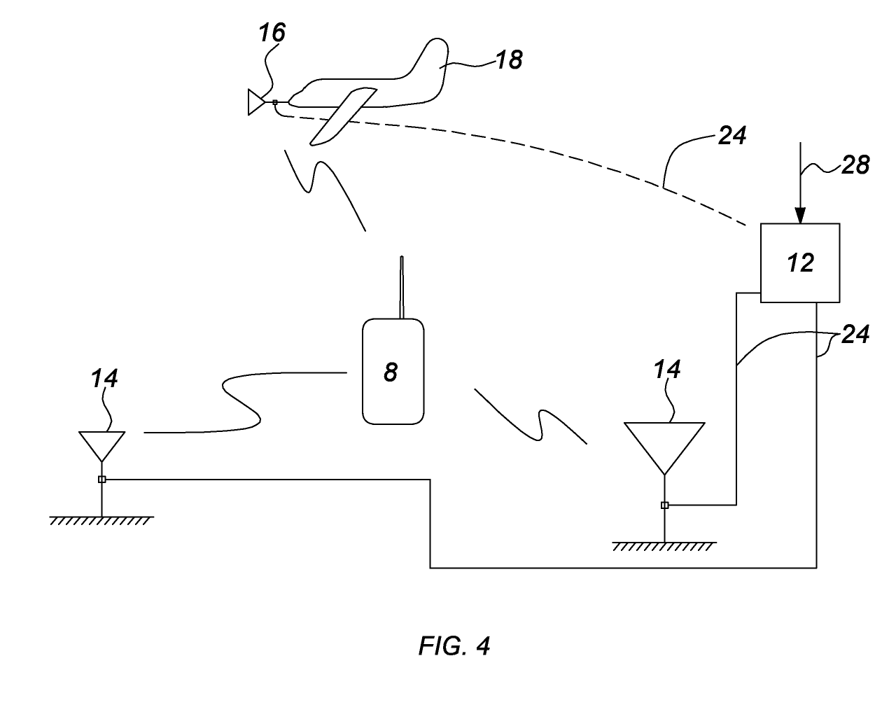

In one embodiment, the present invention is used by having multiple receivers 14 in different geographical locations that are strategically placed around an area of interest such as a marine harbour, park or airfield. Each receiver has the ability to measure TOA and FOA from an emergency beacon 8 as set out above. Each receiver 14 calculates a TOA measurement that is directly related to the distance between the emergency beacon 8 and the receiver 14. Also, each receiver 14 may calculate an FOA measurement which maybe be different depending on if a beacon 14 was in motion or not. The TOA and FOA measurements would be sent via a data link to a central terminal 12 to calculate the geographical position of the emergency beacon 8 and a velocity vector if the beacon was in motion. Optionally, the central terminal may also receive additional external information relating to the location of the emergency beacon, such as by way of non-limiting example, satellite, aircraft or ground determined location, frequency of arrival information, time of arrival information, manually inputted user information as generally indicated at 28. Optionally, the system 10 may include one or more receivers 16 located on an aircraft 18 operable or to provide the TOA and FOA measurement to the processing terminal 12 as illustrated in FIG. 4.

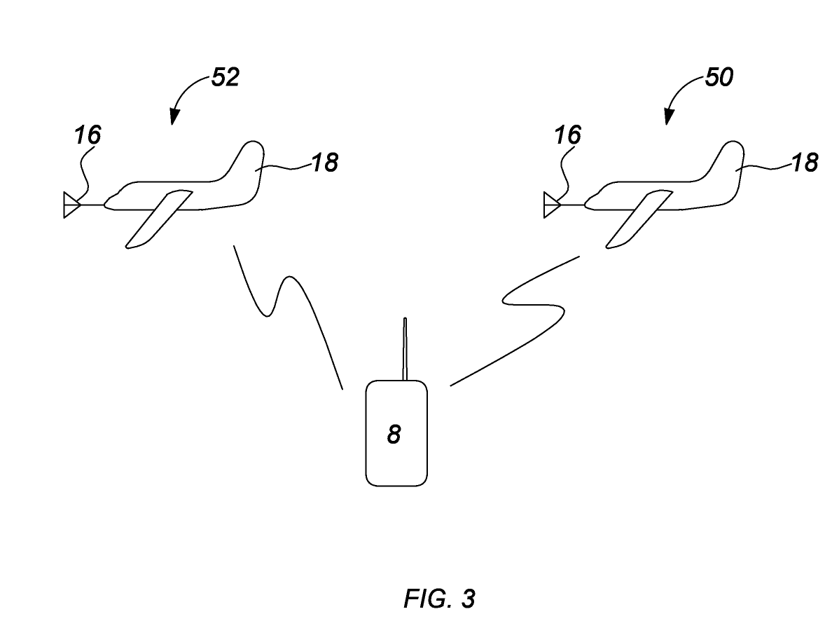

With reference to FIG. 3, a single receiver 16 incorporated located on an aircraft 18 or other suitable vessel and would be traveling in a relatively high degree of motion compared to the emergency beacon 8. The receiver 16 would measure the TOA and FOA measurements at different locations (generally indicated at 50 and 52) during its travel, and then store this information along with the positional data of the receiver into its memory 44. The receiver 16 may then transmit this information to the processing terminal 12 to calculate the geographical position of the emergency beacon 8 when enough data points were collected. Optionally the receiver 16 may calculate the location of the emergency beacon 8 utilizing the processing circuit within the receiver or another suitable associated processing means. Optionally, the processing terminal or the receiver which is designated to calculate the location of the emergency beacon may also receive additional external information relating to the location of the emergency beacon, such as by way of non-limiting example, satellite, aircraft or ground determined location, frequency of arrival information, time of arrival information, manually inputted user information. Optionally, more than one manned or unmanned aircraft mounted receiver 16 may be utilized wherein each of the receivers may calculate a location of the emergency beacon or the TOA and FOA measurements from each receiver may be transmitted to one or more of the receivers for calculation of the emergency beacon location at that receiver.

It will be appreciated that as the land based receivers may be located strategically around locations which such beacons are known to be used, it is possible to provide a greater number of receivers able to receive the transmission from such an emergency beacon. Accordingly, this greater number of receivers with measurements from each receiver can be combined and used to solve a beacon's position much faster. Optionally, the receiver 16 may be configured to determine and output the location of the emergency beacon 8 from such multiple data points in accordance with known methods wherein each of the other receivers transmits the measured TOA and FOA measurements to that receiver as well as optional additional external information relating to the location of the emergency beacon, such as by way of non-limiting example, satellite, aircraft or ground determined location, frequency of arrival information, time of arrival information, manually inputted user information.

In a further embodiment as illustrated in FIG. 6, the present invention is used to compliment the MEOSAR satellite system for the purpose of improving accuracies in localized areas. Due to the improved signal to noise ratios inherent in a terrestrial based receiver, the present invention will contribute a higher degree of accuracy in its TOA and FOA measurements. These measurements would be used in conjunction with the MEOLUT's own measurements and used to calculate a better positional solution than using the satellites alone. The calculation or determination of the location of the emergency beacon may be performed by either a central processing terminal or one of the receivers which may optionally receive additional external information relating to the location of the emergency beacon, such as by way of non-limiting example, satellite, aircraft or ground determined location, frequency of arrival information, time of arrival information, manually inputted user information as generally indicated at 28. The present invention will also augment the MEO satellites geometric orientations which would result in an improved precision of the unassisted MEOSAR system. The present invention may be placed in strategic areas of interest such as marine harbours, parks or airfields.

While specific embodiments of the invention have been described and illustrated, such embodiments should be considered illustrative of the invention only and not as limiting the invention as construed in accordance with the accompanying claims.

What is claimed is:

1. A method for locating a Cospas-Sarsat emergency beacon comprising:
transmitting a Cospas-Sarsat compliant transmission from an emergency beacon;
receiving said transmission at a plurality of receivers wherein said plurality of receivers comprises at least one terrestrial receiver operable to receive said transmission directly from said emergency beacon;
measuring, utilizing a processing circuit, at said at least one terrestrial receiver a frequency of arrival and time of arrival of said transmission; and
calculating the location of said emergency beacon from said frequency of arrivals and said time of arrivals as measured by said plurality of receivers.

2. The method of claim 1 wherein said at least one terrestrial receiver comprises a plurality of terrestrial receivers.

3. The method of claim 1 wherein all of said plurality of receivers comprise terrestrial receivers.

4. The method of claim 1 wherein at least one of said terrestrial receivers is affixed to land.

5. The method of claim 1 wherein said determining comprises receiving information relating to the location of the beacon from external sources.

6. The method of claim 1 wherein said calculating further includes receiving information relating to the location of the beacon from external sources.

7. The method of claim 1 wherein a processing circuit associated with one of said receivers is operable to determine the location of said emergency beacon.

8. The method of claim 1 further comprising transmitting said frequency of arrival and said time of arrival of said transmission to a central processing terminal operable to determine the location of said emergency beacon.

9. A method for locating a Cospas-Sarsat emergency beacon comprising:
transmitting a plurality of Cospas-Sarsat compliant transmissions from an emergency beacon;
receiving said plurality of transmissions at a terrestrial receiver operable to receive said transmission directly from said emergency beacon wherein each of said plurality of transmissions is received at unique locations of said terrestrial receiver;
measuring, utilizing a processing circuit, at said terrestrial receiver a frequency of arrival and time of arrival of each of said plurality of transmissions; and
calculating from said frequency of arrival and time of arrival for said plurality of transmissions the location of said emergency beacon.

10. The method of claim 9 further comprising storing said frequency of arrival and time of arrival of each of said plurality of transmissions and transmitting said frequency of arrival and said time of arrival for each of said plurality of transmissions to a central processing terminal operable to determine the location of said emergency beacon.

11. The method of claim 9 wherein said determining is performed by said processing circuit of said receiver.

12. The method of claim 9 wherein said calculating further includes receiving information relating to the location of the beacon from external sources.

13. A system for locating a Cospas-Sarsat emergency beacon comprising a plurality of receivers wherein said plurality of receivers comprises at least one terrestrial receiver operable to receive said transmission directly from said emergency beacon wherein each of said terrestrial receivers having a processing circuit adapted to determine a frequency of arrival and said time of arrival of a transmission from said emergency beacon.

14. The system of claim 13 wherein said at least one terrestrial receiver comprises a plurality of terrestrial receivers.

15. The system of claim 13 wherein all of said plurality of receivers comprise terrestrial receivers.

16. The system of claim 13 wherein at least one of said terrestrial receivers is affixed to land.

17. The system of claim 13 wherein at least one of said terrestrial receivers is supported on an aircraft.

18. The system of claim 13 wherein a processing circuit associated with one of said receivers is operable to calculate the location of said emergency beacon.

19. The system of claim 18 wherein said central processing terminal is adapted to receive information relating to the location of the beacon from external sources.

20. The system of claim 13 further comprising a central processing terminal in communication with said plurality of receivers operable to calcuate the location of said emergency beacon from said frequency of arrival and said time of arrival as measured by said plurality of receivers.

21. The system of claim 20 wherein said central processing terminal is adapted to receive information relating to the location of the beacon from external sources.
